(19) United States
(12) Patent Application Publication
(10) Pub. No.: US 2017/0167808 A1
(43) Pub. Date: Jun. 15, 2017

(54) APPARATUS FOR PROTECTING NEGATIVE PRESSURE

(71) Applicant: Hyundai Motor Company, Seoul (KR)

(72) Inventors: Su Dong Han, Hwaseong (KR); Hyung Kook Kim, Seongnam (KR)

(21) Appl. No.: 15/091,229

(22) Filed: Apr. 5, 2016

(30) Foreign Application Priority Data
Dec. 11, 2015 (KR) 10-2015-0177180

(51) Int. Cl. F28F 27/00; F16K 17/06; F16K 15/02; B60L 11/18; H01M 8/04029; H01M 8/04746; H01M 8/04701; F28D 15/00; F16K 27/02

(52) U.S. Cl. CPC F28F 27/00; F28D 15/00; F16K 17/06; F16K 15/026; F16K 27/0209; H01M 8/04029; H01M 8/04768; H01M 8/04723; B60L 11/1892; F28D 2021/008

(57) ABSTRACT

An apparatus for protecting negative pressure is provided. The apparatus includes a main flow passage that circulates coolant of a vehicle and includes a section where negative pressure is formed therein. A housing is positioned at the section where the negative pressure of the main flow passage is formed and has a communication aperture that communicates with the main flow passage therein. A negative pressure valve is disposed at the inside of the housing to open or close the communication aperture based on the relationship of an exterior pressure and a valve inside pressure to maintain the valve inside pressure above a predetermined reference value.

### CROSS REFERENCE TO RELATED APPLICATION

The present application claims priority of Korean Patent Application No. 10-2015-0177180 filed on Dec. 11, 2015, the entire contents of which is incorporated herein for all purposes by this reference.

### BACKGROUND

Field of the Invention

The present invention relates to an apparatus for protecting negative pressure to prevent cavitation by precluding negative pressure generation in flow passage of cooling system of a vehicle.

Description of the Related Art

Generally, a cooling system of a vehicle includes a reservoir tank, a radiator and a water pump for circulating coolant. The coolant circulates flow passages formed by the above parts to cool various vehicle parts. Particularly, the cooling system in a fuel cell vehicle is configured to cool stacks using the coolant.

A conventional valve for adjusting negative pressure in the cooling system has been disposed at a radiator cap mounted at a filler neck for inpouring (e.g., introducing) coolant in an uppermost end portion of the radiator causing the valve to have a minimal negative pressure spring constant since it may be possible to refill the coolant at the reservoir tank when the volume of the coolant is reduced. In the conventional cooling system, however, that bubbles were generated by cavitation, vehicle parts were damaged and the flow amount of the coolant was reduced, since various parts were required such as valves dropping coolant pressure in the flow passage from the radiator to the water pump and the coolant pressure at the front end portion of the water pump formed an excessive negative pressure value when the flow amount of the coolant was large.

The foregoing is intended merely to aid in the understanding of the background of the present invention, and is not intended to mean that the present invention falls within the purview of the related art that is already known to those skilled in the art.

### SUMMARY

Accordingly, the present invention provides an apparatus for protecting negative pressure having advantages of preventing bubbles from being generated, vehicle parts from being damaged and the flow amount of the coolant from being reduced by removing cavitation generation by adjusting coolant pressure in cooling system, particularly, a front end portion of a water pump not to be negative pressure (e.g., to be a positive pressure).

In accordance with one aspect of the present invention, an apparatus for protecting negative pressure may include a main flow passage configured to circulate coolant of the vehicle and having a section where negative pressure formed therein, a housing disposed at the section where the negative pressure of the main flow passage is formed and formed with a communication aperture to communicate with the main flow passage therein, and a negative pressure valve disposed at the inside of the housing to open or close the communication aperture based on the relationship between an exterior pressure and a valve inside pressure to maintain the valve inside pressure above a predetermined reference value.

The negative pressure valve may be composed of a neck portion penetrably inserted into the communication aperture; a head portion formed at a lower end portion of the neck portion; and an elastic member spiral-wound along exterior circumference of the neck portion, thereby opening and closing the communication aperture elastically. The diameter of the head portion may be formed to be greater than the inner diameter the communication aperture to open and close the communication aperture by the head portion. The reference value of the valve inside pressure may be tuned by changing a spring constant through altering line diameter and length of the elastic member.

The elastic member may be coupled to the head portion via a coupling member, and the reference value of the valve inside pressure may be tuned by adjusting a rotation amount of the coupling member to adjust an initial compression displacement amount of the elastic member. A first side of the elastic member may be supported at the head portion and a second other side thereof may be supported at an inner side surface of the housing. The negative pressure valve may be maintained in a closed state when the difference between the exterior pressure and the valve inside pressure is less than the predetermined reference value. The negative pressure valve may be opened to resolve the negative pressure when the difference between the exterior pressure and the valve inside pressure is equal to or greater than the predetermined reference value.

The housing may be formed with multi-steps including an upper end portion and a lower end portion, and an inner diameter of the lower end portion may be greater than the inner diameter of the upper end portion to allow the communication aperture to be formed at the side of a locking jaw formed by diameter difference between the upper end portion and the lower end portion. A sealing member may be disposed between the negative pressure valve and the communication aperture for the communication aperture to be sealed when the communication aperture is closed by the negative pressure valve. A first side portion of the housing may be connected to the main flow passage and a second side portion thereof may be connected to the reservoir tank to transmit pressure from the reservoir tank toward the main flow passage when the negative pressure is generated, whereby the negative pressure may be resolved. The negative pressure valve may be disposed in front of the water pump.

Furthermore, a cooling system of a vehicle may include a radiator configured to cool fluid connected to a reservoir tank; a water pump configured to provide power to circulate the fluid; a main flow passage formed for the fluid to be circulated between the radiator and a fuel cell stack; and an apparatus configured to protect negative pressure having a negative pressure valve disposed in front of the water pump and disposed at inside of the housing at which a communication aperture that communicates with a main flow passage is formed to open and close the communication aperture based on the difference between an exterior pressure and a valve inside pressure, thereby maintaining the valve inside pressure equal to or greater than the predetermined reference value.

As apparent from the above description, by the apparatus for protecting negative pressure according to the present invention, when negative pressure is formed above a predetermined reference value, a negative pressure valve may be opened to thus open the flow passage connected to a reservoir tank to transmit pressure from the reservoir tank, thereby resolving the negative pressure and removing cavitation generation in a front end portion of a water pump. Particularly, the reference value of the valve inside pressure may be tuned by altering a spring constant to apply the apparatus for protecting negative pressure according to the present invention to all vehicle types, thereby reducing research and development investment costs through parts sharing and reducing cost.

Furthermore, by supplementing a negative pressure valve of which a position, a reference pressure and operating time may be different from those of the conventional negative pressure valve mounted at a radiator cap in the cooling system of the related art, it may be able to adjust the cooling system pressure and protect cavitation by the negative pressure since two or more of negative pressure adjustment valves having different functions and specifications exist in one cooling system, thereby generating various effects that vehicle parts cannot be damaged by bubbles, cooling performance cannot be deteriorated, the coolant cannot be evaporated by boiling and noise and vibration may be reduced.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a drawing showing a cooling system in which an apparatus for protecting negative pressure according to an exemplary embodiment of the present invention is mounted;

FIG. 2 is a detailed view of portion of FIG. 1 where the apparatus for protecting negative pressure is formed according to an exemplary embodiment of the present invention is mounted;

FIG. 3 is a drawing showing a negative pressure valve in FIG. 2 to be closed according to an exemplary embodiment of the present invention is mounted;

FIG. 4 is a drawing showing the negative pressure valve in FIG. 2 to be opened according to an exemplary embodiment of the present invention is mounted; and

FIG. 5 is a drawing showing an apparatus for protecting negative pressure according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, an apparatus for protecting negative pressure according to an exemplary embodiment of the present invention will be described with reference to the accompanying drawings.

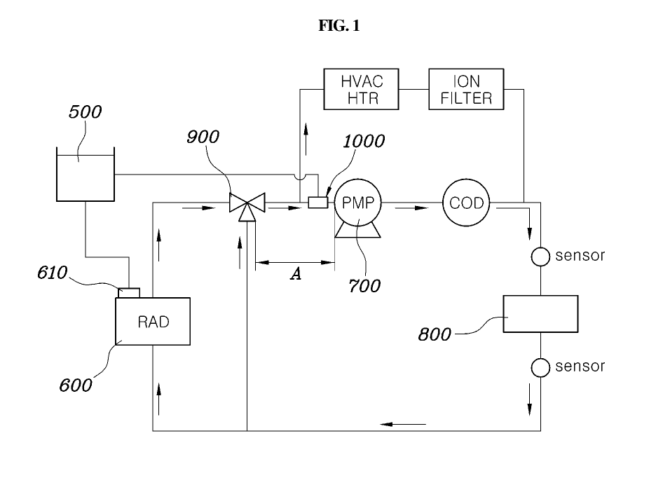

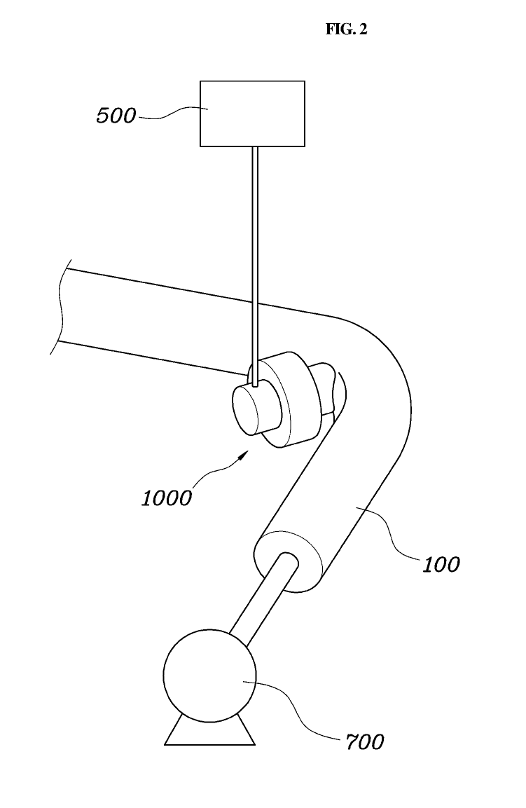

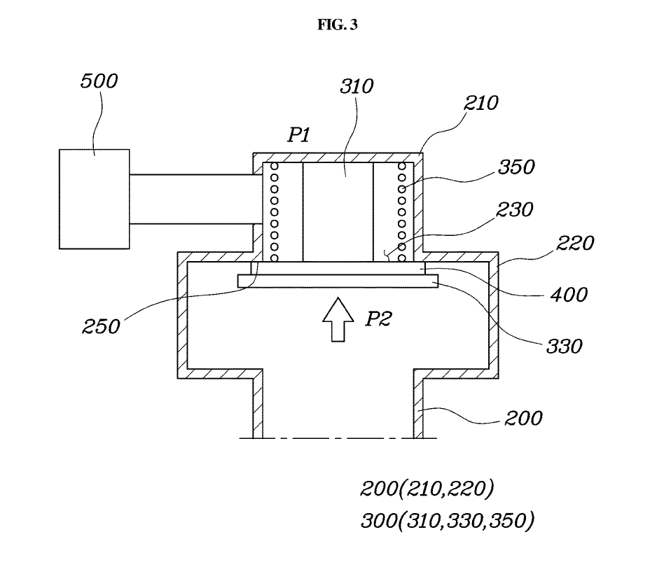

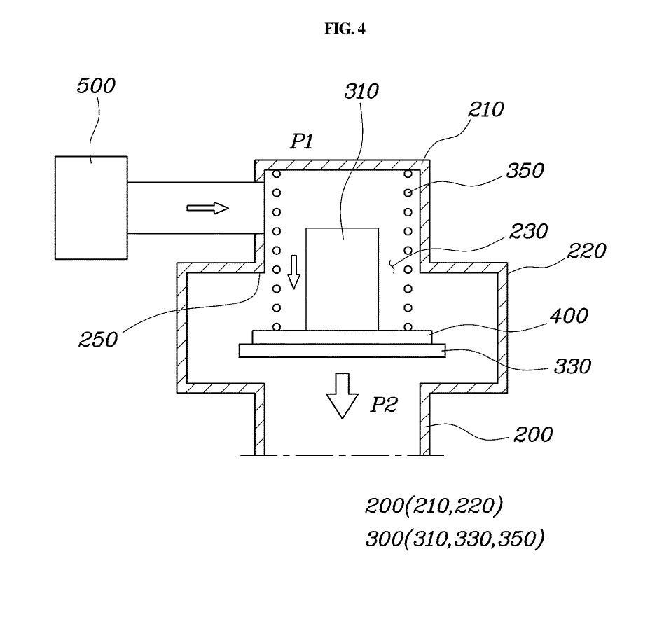

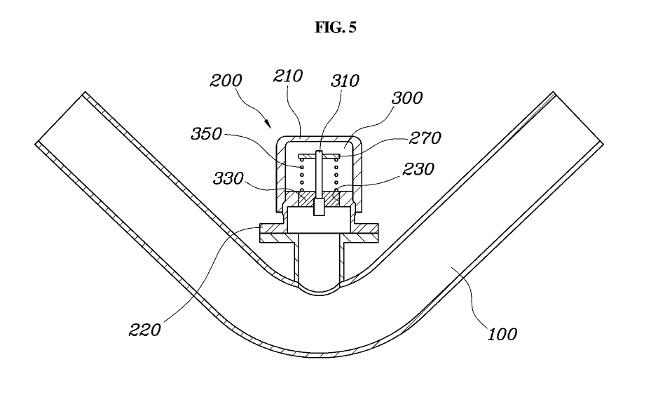

FIG. 1 is a drawing showing a cooling system in which an apparatus 1000 for protecting negative pressure according to an exemplary embodiment of the present invention is mounted. FIG. 2 is a detailed view of portion of FIG. 1 where the apparatus 1000 for protecting negative pressure is formed. Further, FIG. 3 is a drawing showing a negative pressure valve 300 in FIG. 2 to be closed. FIG. 4 is a drawing showing the negative pressure valve 300 in FIG. 2 to be opened. Furthermore, FIG. 5 is a drawing showing an apparatus 1000 for protecting negative pressure according to another exemplary embodiment of the present invention.

The apparatus for protecting negative pressure of the present invention will be described in detail with reference to the drawings. As shown in FIG. 2 to FIG. 4, an apparatus for protecting negative pressure according to an exemplary embodiment of the present invention may include a main flow passage 100 configured to circulate coolant and includes a section where negative pressure is formed therein; a housing 200 positioned at the section where the negative pressure of the main flow passage 100 is formed and includes a communication aperture 230 that communicates with the main flow passage 100 therein; and a negative pressure valve 300 disposed at the inside of the housing 200 to open or close the communication aperture 230 based on the relationship between an exterior pressure P1 and a valve inside pressure P2 to maintain the valve inside pressure P2 above a predetermined reference value Pcr. In particular, the valve inside pressure P2 may refer to an inside pressure of a cooling system.

Since the apparatus for protecting negative pressure 1000 of the present invention is intended to protect the negative pressure in the cooling system, the apparatus for protecting negative pressure 1000 may be disposed at the position where the negative pressure is generated among the main flow passage 100. The water pump 700 may be positioned at a lowest portion in the cooling system to continuously circulate coolant even when water head is down. Therefore, when there are substantial pressure-dropping parts or a plurality of sealing parts at a front end portion of the water pump 700, the head of the water pump 700 may be formed towards the negative pressure to allow cavitation to occur. Therefore, the apparatus for protecting negative pressure 1000 may be disposed in front of the water pump 700, that is, at the place where the negative pressure of the main flow passage 100 is generated, more particularly, between the radiator 600 and the water pump 700, further more particularly, at the place A between 3-ways valve and the water pump 700 where the negative pressure is most frequently formed, thereby protecting negative pressure formation at the place A.

The main flow passage 100 may be formed with a “V”-shape as shown in FIG. 2. Therefore, the housing 200 may be disposed at a “V”-shaped bent portion of the main flow passage 100 for the apparatus for protecting negative pressure 1000 to operate more rapidly and accurately to realize the effects of negative pressure formation protect powerfully, by providing the apparatus for protecting negative pressure 1000 at the place where the negative pressure is formed to be greater.

One side portion (e.g., a first side portion) of the housing 200 may be connected to the main flow passage 100 and the other side portion (e.g., a second side portion) thereof may be connected to the reservoir tank 500 to transmit pressure from the reservoir tank 500 toward the main flow passage 100 when the negative pressure is generated in the main flow passage 100, whereby the negative pressure is resolved. Particularly, the reservoir tank 500 may be connected to a side portion of the housing 200.

The housing 200 may be formed with multi-steps (e.g., with different levels) having an upper portion 210 and a lower portion 220 as shown in drawings. Particularly, the inner diameter of the lower portion 220 in the housing 200 may be greater than the inner diameter of the upper portion 210 to allow a locking jaw 250 to be formed by diameter difference between the upper end portion 210 and the lower end portion 220. The communication aperture 230 may be formed at the side of the locking jaw 250. In other words, the communication aperture 230 may not be formed separately but may be formed as a part of the flow passage of the cooling system that communicates with the main flow passage 100 in the housing 200.

Furthermore, according to another exemplary embodiment of the present invention as shown in FIG. 5, the negative pressure valve 300 may be directly mounted at an end portion of the housing 200. The coupling relationship between the housing 200 and the negative pressure valve 300 is not particularly limited to the above configuration and may be changed based on design or circumstance when the valve inside pressure P2 can be resolved through a valve configuration. Therefore, the negative pressure valve 300 may be disposed at the inside of the housing 200 to open or close the communication aperture 230 based on the relationship between the exterior pressure P1 and the valve inside pressure P2 to maintain the valve inside pressure P2 above a predetermined reference value Pcr.

The negative pressure valve 300 may be composed of a neck portion 310 penetrably inserted into the communication aperture 230, a head portion 330 formed at a lower end portion of the neck portion 310, and an elastic member 350 spiral-wound along exterior circumference of the neck portion 310, to elastically open and close the communication aperture 230. The elastic member 350 may be a coil spring. Particularly, the diameter of the head portion 330 may be greater than the inner diameter of the communication aperture 230 to open and close the communication aperture 230 by the head portion 330. Further, a sealing member 400 may be disposed between the negative pressure valve 300 and the communication aperture 230 to seal the communication aperture 230 when the communication aperture 230 is closed by the negative pressure valve 300. The sealing member 400 may be formed with a size that corresponds to the head portion 330 and may be made from a rubber material.

As described above, the negative pressure valve 300 may be disposed at an end portion of the housing 200. Therefore, one side portion (e.g., a first side) of the elastic member 350 may be supported at the head portion 330 and the other side portion (e.g., a second side) thereof may be supported at an inner surface of the housing 200 to support the upper and lower direction movement of the head portion 330 and the neck portion 310 when the negative pressure valve 300 is opened and closed.

Hereinafter, the opening and closing motion of the negative pressure valve 300 will be described through FIG. 3 to FIG. 4. When the difference between the exterior pressure P1 and the valve inside pressure P2 is less than the predetermined reference value Pcr as like FIG. 3, the negative pressure valve 300 may maintain the closed state. Particularly, when the difference between the exterior pressure P1 and the valve inside pressure P2 is less than the predetermined reference value Pcr which is set when designing a vehicle, the negative pressure valve 300 may be configured to close the communication aperture 230 (e.g., P1−P2<Pcr). In other words, the negative pressure valve 300 may continue to receive pressure from the valve inside pressure P2. As described above, that the closing of the negative pressure valve 300 may cause a rapid increase of the coolant temperature due to the high output of the fuel cell stack 800 and a rapid decrease of revolutions per minute (RPM) in the water pump 700 while a vehicle is being driven.

By contrast, when the difference between the exterior pressure P1 and the valve inside pressure P2 is equal to or greater than the predetermined reference value Pcr as shown in FIG. 4, the negative pressure valve 300 may be opened to resolve the negative pressure formed inside of the main flow passage 100. Particularly, when the difference between the exterior pressure P1 and the valve inside pressure P2 is equal to or greater than the predetermined reference value Pcr which is set when designing a vehicle, the negative pressure valve 300 may be configured to open the communication aperture 230 (e.g., P1−P2≧Pcr). Therefore, the pressure of the reservoir tank 500 may be transmitted to the main flow passage 100 through the communication aperture 230 of the housing 200 to resolve the negative pressure formed inside of the main flow passage 100.

Accordingly, the cavitation at the front end portion of the water pump 700 may be prevented. As described above, the opening of the negative pressure valve 300 may cause a rapid decrease of the coolant temperature, a rapid increase of RPM in the water pump 700 and a stable state in which high RPM is maintained after rapidly increasing of RPM in the water pump 700 while a vehicle is being driven. The reference value Pcr of the valve inside pressure P2 may be about 20 kPa. By changing a spring constant through altering line diameter and length of the elastic member 350, etc., there is an advantage capable of tuning to set the reference value Pcr of the valve inside pressure P2 corresponding to each characteristic of the vehicle type.

Furthermore, the elastic member 350 may be coupled to the head portion 330 via a coupling member 279 in another exemplary embodiment of the present invention as shown in FIG. 5. The coupling member 270 may be a rotating nut. Therefore, by adjusting the rotation amount of the coupling member 270 even when the spring constant remains the same by applying one elastic member 350 to another vehicle type, the effect of applying the different reference value Pcr of the valve inside pressure P2 may be obtained by adjusting the initial compression displacement amount of the elastic member 350. Therefore, since the spring constant may be tuned even when equally applying the elastic member 350 for different vehicle types, the effect that the elastic member 350 having different spring constant is applied thereto, respectively may be obtained.

The apparatus for protecting negative pressure of the present invention may be applied to a fuel cell vehicle as environmentally-friendly vehicle. The cooling system of the fuel cell vehicle may include the radiator 600 configured to cool fluid connected to the reservoir tank 500; the water pump 700 configured to provide power to circulate the fluid; and the main flow passage 100 in which the fluid may circulate between the radiator 600 and the fuel cell stack 800. As like shown in FIG. 1, a bypass flow passage may be formed and the 3-ways valve may be add thereto accordingly.

Even when the water head of the water pump 700 is dropped down in the fuel cell vehicle, the water pump 700 may be disposed at a lowest end portion of the cooling system to continuously maintain coolant circulation. Unlike a negative pressure valve (not shown) mounted at the radiator cap 610, a negative valve may be additionally disposed in front of the water pump 700, more particularly, at a position where the negative pressure is formed between the 3-ways valve and the water pump 700. Therefore, the apparatus for protecting negative pressure 1000 may be disposed within the cooling system of the present invention, which includes the negative pressure valve 300 disposed in front of the water pump 700 and disposed at inside of the housing 200 at which the communication aperture 230 communicates with the main flow passage 100 is formed, to cause the negative pressure valve 300 to open and close the communication aperture 230 based on the difference between the exterior pressure P1 and the valve inside pressure P2, to thus maintain the valve inside pressure P2 equal to or greater than the predetermined reference value Pcr.

Typically, when a substantial amount of pressure-dropping parts or a plurality of sealing parts are disposed in front end portion of the water pump, the head of the water pump may be formed towards the negative pressure to cause cavitation. Accordingly, a number of disadvantages occur including, that a substantial amount of bubbles are generated, noise is generated, and flow amount is reduced. However, according to the apparatus for protecting negative pressure as described above, when the negative pressure equal to or greater than the predetermined reference value Pcr is formed, the negative pressure valve 300 may be opened 300 to open the flow passage connected to the reservoir tank 500 to transmit pressure from the reservoir tank 500 to resolve the negative pressure, to prevent and remove cavitation generation in front end portion of the water pump 700.

Particularly, the claimed invention is capable of tuning the reference value of the valve inside pressure through altering a spring constant to be capable of applying the apparatus for protecting negative pressure to multiple vehicle types, thereby reducing research and development investment costs through parts sharing and reducing cost. Furthermore, by supplementing a negative pressure valve of which a position, a reference pressure and operating time are different from those of the conventional negative pressure valve mounted at a radiator cap in the cooling system of the related art, it may be possible to adjust the cooling system pressure and protect cavitation by the negative pressure since two or more of negative pressure adjustment valves having different functions and specifications are disposed in one cooling system, thereby preventing parts from being damaged by bubbles, preventing deterioration of cooling performance, preventing the evaporation of the coolant by boiling and reducing noise and vibration.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for protecting negative pressure, comprising:
a main flow passage configured to circulate coolant of a vehicle and having a section where negative pressure is formed therein;
a housing positioned at the section where the negative pressure of the main flow passage is formed and having a communication aperture that communicates with the main flow passage therein; and
a negative pressure valve disposed at the inside of the housing to open or close the communication aperture based on the relationship between an exterior pressure and a valve inside pressure to maintain the valve inside pressure above a predetermined reference value.

2. The apparatus for protecting negative pressure of claim 1, wherein the negative pressure valve includes:
a neck portion penetrably inserted into the communication aperture;
a head portion formed at a lower end portion of the neck portion; and
an elastic member spiral-wound along exterior circumference of the neck portion, to elastically open and close the communication aperture.

3. The apparatus for protecting negative pressure of claim 2, wherein the diameter of the head portion is greater than the inner diameter the communication aperture to open and close the communication aperture by the head portion.

4. The apparatus for protecting negative pressure of claim 2, wherein the reference value of the valve inside pressure is tuned by changing a spring constant through altering line diameter and length of the elastic member.

5. The apparatus for protecting negative pressure of claim 2, wherein the elastic member is coupled to the head portion via a coupling member, and the reference value of the valve inside pressure is tuned by adjusting a rotation amount of the coupling member to adjust an initial compression displacement amount of the elastic member.

6. The apparatus for protecting negative pressure of claim 2, wherein a first side of the elastic member is supported at the head portion and a second side thereof is supported at an inner side surface of the housing.

7. The apparatus for protecting negative pressure of claim 1, wherein the negative pressure valve is maintained in a closed state when the difference between the exterior pressure and the valve inside pressure is less than the predetermined reference value.

8. The apparatus for protecting negative pressure of claim 1, wherein the negative pressure valve is opened to resolve the negative pressure when the difference between the exterior pressure and the valve inside pressure is equal to or greater than the predetermined reference value.

9. The apparatus for protecting negative pressure of claim 1, wherein the housing is formed with multi-levels including an upper end portion and a lower end portion, and an inner diameter of the lower end portion is greater than the inner diameter of the upper end portion to allow the communication aperture to be formed at a side of a locking jaw formed by diameter difference between the upper end portion and the lower end portion.

10. The apparatus for protecting negative pressure of claim 1, wherein a sealing member is disposed between the negative pressure valve and the communication aperture to seal the communication aperture when the communication aperture is closed by the negative pressure valve.

11. The apparatus for protecting negative pressure of claim 1, wherein a first side portion of the housing is connected to the main flow passage and a second side portion thereof is connected to the reservoir tank to transmit pressure from the reservoir tank toward the main flow passage when the negative pressure is generated, to resolve the negative pressure is.

12. The apparatus for protecting negative pressure of claim 1, wherein the negative pressure valve is disposed in front of the water pump.

13. A cooling system of a vehicle, comprising:
a radiator configured to cool fluid connected to a reservoir tank;
a water pump configured to provide power to circulate the fluid;
a main flow passage formed for the fluid to be circulated between the radiator and a fuel cell stack; and
an apparatus for protecting negative pressure including:
a negative pressure valve disposed in front of the water pump and at inside of the housing at which a communication aperture that communicates with a main flow passage is formed to open and close the communication aperture based on the difference between an exterior pressure and a valve inside pressure, to maintain the valve inside pressure equal to or greater than the predetermined reference value.

14. The cooling system of claim 13, wherein the negative pressure valve includes:
a neck portion penetrably inserted into the communication aperture;
a head portion formed at a lower end portion of the neck portion; and
an elastic member spiral-wound along exterior circumference of the neck portion, to elastically open and close the communication aperture.

15. The cooling system of claim 14, wherein the diameter of the head portion is greater than the inner diameter the communication aperture to open and close the communication aperture by the head portion.

16. The cooling system of claim 14, wherein the reference value of the valve inside pressure is tuned by changing a spring constant through altering line diameter and length of the elastic member.

17. The cooling system of claim 14, wherein the elastic member is coupled to the head portion via a coupling member, and the reference value of the valve inside pressure is tuned by adjusting a rotation amount of the coupling member to adjust an initial compression displacement amount of the elastic member.

18. The cooling system of claim 14, wherein a first side of the elastic member is supported at the head portion and a second side thereof is supported at an inner side surface of the housing.
